(19) United States
(12) Patent Application Publication
(10) Pub. No.: US 2003/0014439 A1
(43) Pub. Date: Jan. 16, 2003

(54) Defining a markup language representation for state chart data

(75) Inventor: Akram Boughannam, Lake Worth, FL (US)

Correspondence Address: Gregory A. Nilson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY

(21) Appl. No.: 09/885,705

(22) Filed: Jun. 20, 2001

(51) Int. Cl. G06F 15/00

(52) U.S. Cl. 707/513

(57) ABSTRACT

A state machine system can include a state machine modeling tool, the modeling tool producing UML specified state chart diagrams; a conversion script add-in to the state machine modeling tool, the add-in defining markup language representations of the UML specified state chart diagrams produced by the state machine modeling tool; and, a state machine run-time engine which is separate from the state machine modeling tool, the run-time engine executing the markup language representations defined by the add-in. The markup language representations can be XML representations of the UML specified state chart diagrams.

### BACKGROUND OF THE INVENTION

1. Technical Field

This invention relates to the field of object modeling and more particularly to a system and method for defining a markup language representation of state chart data.

2. Description of the Related Art

The unified modeling language (UML) supports the analysis, design, visualization and development of complex systems. The UML consists of nine different diagram types, each diagram type showing a specific static or dynamic aspect of a system, each diagram graphically representing underlying object data. One such diagram type, the state chart diagram, specifies the behavior of an object and how that behavior differs from state to state. Specifically, state chart diagrams capture the life cycles of objects, subsystems and systems. State chart diagrams indicate what states an object can have and how different events affect those states over times. An object changes state when an event occurs.

State chart diagrams can have a starting point and several end points. A starting point, or initial state, is represented with a solid circles; an end point or final state is represented with a small solid circles surrounded by a larger empty circle, thereby forming a bulls-eye. A state is represented by a rectangle with rounded corners. Changes in states, or state transitions, are indicated with a line ending in an arrow pointing from one state to another. The state transition is labeled with its cause. When the event occurs, the transition from one state to another is performed. Notably, UML state chart diagrams have been used not only to successfully model software systems, but also to model hardware design and business process engineering. Presently, various modeling tools have been developed to support the UML state chart modeling of these systems. One such modeling tool includes the Rational Rose® suite of modeling tools manufactured by Rational Software Corporation of Lexington, Mass., USA.

Many modeling tools support extensibility. Specifically, the functionality of modeling tools can be extended by customized programs created by a user with conventional programming language tools and incorporated into the modeling tool. For example, in the Rational Rose suite of modeling tools, the functionality of the modeling tools can be extended through the RoseScript® language and the Rose Extensibility Interface®. The RoseScript Language is a language which includes statements and functions commonly associated with the Visual Basic® programming language manufactured by Microsoft Corporation of Redmond, Wash., USA. By comparison, the Rose Extensibility Interface includes Rational Rose-specific extensions to Visual Basic. Using RoseScript and the Rose Extensibility Interface, a developer can access the functionality of selected Rational Rose tools. Typical uses of RoseScript and the Rose Extensibility Interface include the generation of computer program code, the computation of metrics, the preparation of documentation and the reverse engineering of existing computer program code.

In addition to modeling state machines, conventional state machine modeling tools include state machine run-time engines for executing a state machine described by a state chart diagram. Typically, state machine based systems do not separate the state machine run-time engine from the modeling tool. Rather, the tool used to create a state chart diagram also include the run-time engine. Notwithstanding, presently there exists state machine run-time engines which do not also include a modeling tool for producing state chart diagrams. In particular, such stand-alone run-time engines can process documents which describe state machines in order to execute the described state machine. In many instances, these documents can be formatted using well-known markup languages such as HTML, XML, WML and the like. Still, manually producing markup language representations of state chart diagrams can be both time consuming and error-prone. Accordingly, what is needed is a more effective method and system for defining markup language representations for state chart data produced by conventional modeling tools.

### SUMMARY OF THE INVENTION

The present invention can efficiently define markup language representations for state chart data produced by conventional modeling tools. A method for defining a markup language representation for state chart data can include the steps of: loading state chart data corresponding to a state chart diagram through an interface to a state machine modeling tool; generating header and footer data in accordance with a selected markup language; for each state specified in the state chart data, retrieving a state name and state transition data from the state chart data; formatting the retrieved state names and corresponding state transition data according to the selected markup language; and, saving the header and footer data, and the formatted state names and state transition data in an document formatted according to the selected markup language.

The method can further include the steps of: for each state specified in the state chart data, extracting a composite state action; parsing the composite state action into individual state actions; formatting each individual state action according to the selected markup language; and, saving the formatted individual state actions in the document. Notably, the selected markup language can be the extensible markup language (XML). Also, the state chart diagram can be a unified modeling language (UML) specified state chart. As a result, the method can further include the step of defining a document type definition (DTD) which defines XML elements for use in formatting the state chart data. Moreover, the formatting step can include the step of formatting the retrieved state names and corresponding state transition data according to the XML elements defined in the DTD.

A system for defining a markup language representation of a state chart can include a state machine modeling tool for generating state chart data; and, an add-in script to the state machine modeling tool for formatting the state chart data into a markup language representation according to a selected markup language. The selected markup language can be the XML. Furthermore, the generated state chart data can be UML specified state chart data. The system also can include a DTD which defines XML elements for use in formatting the state chart data into the markup language representation.

A system for linking a state machine modeling tool with a state machine run-time engine can include a state chart diagram generated by the state machine modeling tool, the state chart diagram comprising state chart data, the state chart data comprising state chart names, transition data and composite state actions; a state action parser for parsing the composite state actions into component state actions; and, a markup language formatter for formatting the state chart data and component state actions according to a selected markup language. The state chart diagram can be a UML specified state chart diagram. The selected markup language can be XML.

A state machine system can include a state machine modeling tool, the modeling tool producing UML specified state chart diagrams; a conversion script add-in to the state machine modeling tool, the add-in defining markup language representations of the UML specified state chart diagrams produced by the state machine modeling tool; and, a state machine run-time engine which is separate from the state machine modeling tool, the run-time engine executing the markup language representations defined by the add-in. The markup language representations can be XML representations of the UML specified state chart diagrams.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 is a pictorial representation of a state machine modeling tool linked to a separate state machine run-time engine in accordance with the inventive arrangements.

FIG. 2 is a block diagram depicting a process for defining a markup language representation of a state chart diagram produced by a state machine modeling tool.

FIG. 3 is a flow chart illustrating a process for defining an XML representation of a UML specified state chart diagram produced by a state machine modeling tool.

### DETAILED DESCRIPTION OF THE INVENTION

The present invention is a state chart modeling and processing system in which a state chart diagram can be produced in a state machine modeling tool, a markup language representation can be defined for the state chart diagram, and the markup language representation of the state chart diagram can be executed by a separate state machine run-time engine. More particularly, the system can include a state machine modeling tool which can produce state chart diagrams. A conversion script add-in can be included with the state machine modeling tool which defines markup language representations of the state chart diagrams produced by the state machine modeling tool. Finally, a state machine run-time engine can be provided which is separate from the state machine modeling tool. The state machine run-time engine can execute the markup language representations defined by the conversion script add-in. Notably, the state chart diagrams can be specified according to the UML. Additionally, the markup language representations can be XML representations of the state chart diagrams.

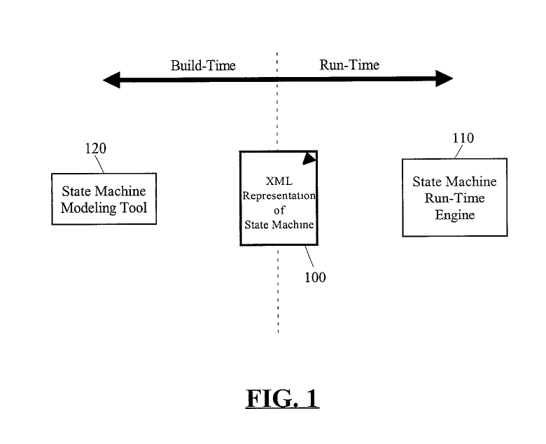

FIG. 1 is a pictorial representation of a state chart modeling and processing system. The system can include a state machine modeling tool 120 linked to a separate state machine run-time engine 110 in accordance through a common markup language representation 100 of a state chart diagram. The state machine modeling tool 120 can be utilized during a build-time phase in which a state chart diagram can be produced. By comparison, the state-machine run-time engine 110 can be utilized during a run-time phase in which the state chart diagram produced by the state machine modeling tool 120 can be executed in order to implement the system modeled by the state chart diagram. Importantly, though the markup language representation 100 can be an XML representation, the invention is not limited in this regard and other markup languages can be equivalently utilized, for example HTML, other SGML derivatives, and the like.

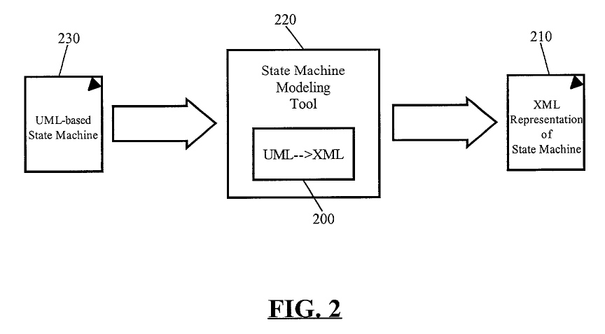

FIG. 2 is a block diagram depicting a process for defining a markup language representation 210 of a UML-specified state chart diagram 230 produced by a state machine modeling tool 220. In particular, the state machine modeling tool can produce a state chart diagram 230 in accordance with conventional methods for producing a state chart diagram known in the art. Notably, the state chart diagram 230 can be a UML specified state chart diagram, although the invention is not limited in regard to the particular modeling language used to specify the state chart diagram. Once produced, a conversion script add-in 200 to the state machine modeling tool 120 can process the state chart diagram 230 in order to produce an XML representation 100 of the state chart diagram 230.

More particularly, the conversion script add-in 200 can be a computer program, for instance an ActiveX DLL, which can be integrated into the state machine modeling tool 120 according to conventional methods well known in the art. For example, in the case of the Rational Rose modeling tool, it is well-known how to produce and integrate RoseScript based programs into the Rational Rose suite of modeling tools with assistance from the Rose Extensibility Interface. Notwithstanding, the invention is not limited in regard to the use of any particular modeling tool. Rather, the present invention contemplates other modeling tools which can be extended in a manner similar to the Rational Rose modeling tool.

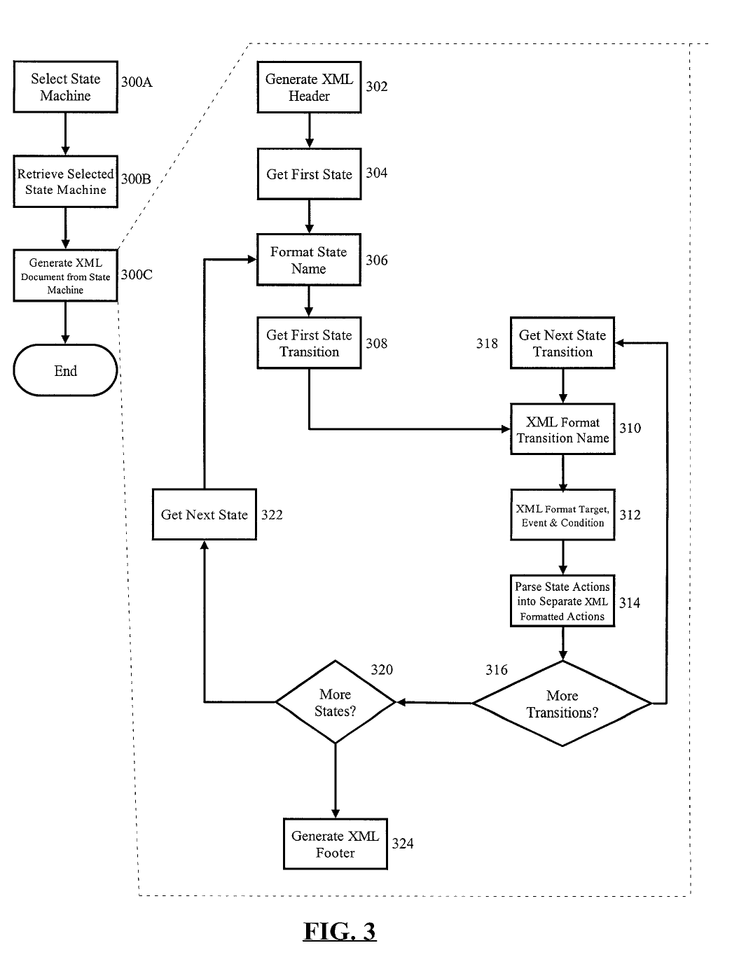

FIG. 3 is a flow chart illustrating a process for defining an XML representation of a UML specified state chart diagram produced by a state machine modeling tool as illustrated in FIG. 2. In a preferred aspect of the present invention, the process can be performed in a script add-in to a state machine modeling tool. Notably, a user interface can be provided through which a user can interact with the script add-in. In general, the process can begin in block 300A in which a user can select a pre-constructed state chart diagram produced by a state machine modeling tool. In one aspect of the present invention, the user can select the pre-constructed state chart diagram through the use of a file-open dialog box or other such user interface mechanism.

Once a pre-constructed state chart diagram has been selected, in block 300B the selected state chart diagram can be retrieved from storage and loaded into memory. In block 300C, the script add-in can generate an XML document based upon the state chart data represented by the selected state chart diagram. In particular, each state name, associated state transitions and other state chart data, for example state actions, can be retrieved from memory and formatted according to specified XML tags pre-defined in the script add-in and specified in a corresponding document type definition (DTD) file. An exemplary DTD could be defined as follows:

| <?xml encoding=“US-ASCII”?> | |
|---|---|
| <!ELEMENT | statemachine (state+)> |
| <!ATTLIST | statemachine |

| | | |
|---|---|---|
| id | ID | #REQUIRED |
| name | CDATA | #REQUIRED> |

| | |
|---|---|
| <!ELEMENT | state (transition+)> |

| | | |
|---|---|---|
| id | ID | #REQUIRED |
| name | CDATA | #REQUIRED> |

| | | |
|---|---|---|
| <!ATTLIST | state | |
| <!ELEMENT | transition | (target, event, condition, action)> |
| <!ATTLIST | transition | |

| | | |
|---|---|---|
| id | ID | #REQUIRED |
| name | CDATA | #REQUIRED> |

| | |
|---|---|
| <!ELEMENT | target (#PCDATA)> |
| <!ELEMENT | event (#PCDATA)> |
| <!ELEMENT | condition(name, value) (#PCDATA)> |
| <!ELEMENT | action(name, value)> |
| <!ELEMENT | name (#PCDATA)> |
| <!ELEMENT | value (#PCDATA)> |

Subsequently, each XML formatted state chart element can be written to an XML document including suitable XML header and footer information.

Notably, blocks 302 through 324 describe in further detail the process specified in block 300C. Specifically, in block 302, prior to retrieving state chart data, an XML header can be written to the XML document. Subsequently, in block 304, a first state can be retrieved from memory. State chart data included in the retrieved state chart diagram can be accessed in accordance with the API provided by the state machine modeling tool. For example, in the case of Rational Rose®, the Rose Extensibility Interface provides the necessary interface to access data elements in the state chart diagrams. In any case, in block 306, a state name can be determined from the state chart data. Also, in block 308, a first state transition associated with the first state can be determined.

Once a first state transition has been determined, the transition name can be extracted in block 310 and XML formatted in accordance with the DTD. Additionally, in block 312 the target, event and condition can also be extracted and XML formatted in accordance with the DTD. Significantly, in some state machine modeling tools such as Rational Rose, only one state action can be specified in association with a particular state. To circumvent this limitation, oftentimes, multiple state actions are specified in a composite state action in which each state action is denoted by separating commas. In consequence, in block 314, any composite state action can be parsed into component state actions, where each state action can subsequently be XML formatted in accordance with the DTD.

In block 316, this process can repeat for each transition associated with the first state. When no more transitions remain, in block 320 and 322, the overall process can is repeat for additional states in the state chart diagram. Finally, when no more states remain, in block 324 suitable XML footer information can be written to the XML document and the process can be completed. In this way, the state chart diagram produced by the state machine modeling tool can be converted to an XML representation.

The present invention can be realized in hardware, software, or a combination of hardware and software. The present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which when loaded in a computer system is able to carry out these methods.

Computer program means or computer program in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

I claim:

1. A method for defining a markup language representation of state chart data comprising the steps of:
loading state chart data corresponding to a state chart diagram through an interface to a state machine modeling tool;
generating header and footer data in accordance with a selected markup language;
for each state specified in said state chart data, retrieving a state name and state transition data from said state chart data;
formatting said retrieved state names and corresponding state transition data according to said selected markup language; and,
saving said header and footer data, and said formatted state names and state transition data in an document formatted according to said selected markup language.

2. The method of claim 1, further comprising the steps of:
for each state specified in said state chart data, extracting a composite state action;
parsing said composite state action into individual state actions;
formatting each individual state action according to said selected markup language; and,
saving said formatted individual state actions in said document.

3. The method of claim 1, wherein said selected markup language is the extensible markup language (XML).

4. The method of claim 1, wherein said state chart diagram is a unified modeling language (UML) specified state chart.

5. The method of claim 3, further comprising the step of defining a document type definition (DTD) which defines XML elements for use in formatting said state chart data.

6. The method of claim 5, wherein said formatting step comprises formatting said retrieved state names and corresponding state transition data according to said XML elements defined in said DTD.

7. A system for defining a markup language representation of state chart data comprising:
a state machine modeling tool for generating state chart data; and,
an add-in script to said state machine modeling tool for formatting said state chart data into a markup language representation according to a selected markup language.

8. The system of claim 7, wherein said selected markup language is the extensible markup language (XML).

9. The system of claim 8, wherein said generated state chart data is unified modeling language (UML) specified state chart data.

10. The system of claim 8, further comprising a document type definition (DTD) which defines XML elements for use in formatting said state chart data into said markup language representation.

11. A system for linking a state machine modeling tool with a state machine run-time engine comprising:
a state chart diagram generated by the state machine modeling tool, said state chart diagram comprising state chart data, said state chart data comprising state chart names, transition data and composite state actions;
a state action parser for parsing said composite state actions into component state actions; and,
a markup language formatter for formatting said state chart data and component state actions according to a selected markup language.

12. The system of claim 11, wherein said state chart diagram is a unified modeling language (UML) specified state chart diagram.

13. The system of claim 11, wherein said selected markup language is the extensible markup language (XML).

14. A state machine system comprising:
a state machine modeling tool, said modeling tool producing unified modeling language (UML) specified state chart diagrams;
a conversion script add-in to said state machine modeling tool, said add-in defining markup language representations of said UML specified state chart diagrams produced by said state machine modeling tool; and,
a state machine run-time engine which is separate from said state machine modeling tool, said run-time engine executing said markup language representations defined by said add-in.

15. The system of claim 14, wherein said markup language representations are extensible markup language (XML) representations of said UML specified state chart diagrams.

16. A machine readable storage, having stored thereon a computer program for defining a markup language representation for state chart data, said computer program having a plurality of code sections executable by a machine for causing the machine to perform the steps of:
loading state chart data corresponding to a state chart diagram through an interface to a state machine modeling tool;
generating header and footer data in accordance with a selected markup language;
for each state specified in said state chart data, retrieving a state name and state transition data from said state chart data;
formatting said retrieved state names and corresponding state transition data according to said selected markup language; and,
saving said header and footer data, and said formatted state names and state transition data in an document formatted according to said selected markup language.

17. The machine readable storage of claim 16, further comprising the steps of:
for each state specified in said state chart data, extracting a composite state action;
parsing said composite state action into individual state actions;
formatting each individual state action according to said selected markup language; and,
saving said formatted individual state actions in said document.

18. The machine readable storage of claim 16, wherein said selected markup language is the extensible markup language (XML).

19. The machine readable storage of claim 16, wherein said state chart diagram is a unified modeling language (UML) specified state chart.

20. The machine readable storage of claim 18, further comprising the step of defining a document type definition (DTD) which defines XML elements for use in formatting said state chart data.

21. The machine readable storage of claim 20, wherein said formatting step comprises formatting said retrieved state names and corresponding state transition data according to said XML elements defined in said DTD.
